(19) United States
(12) Patent Application Publication
(10) Pub. No.: US 2024/0356133 A1
(43) Pub. Date: Oct. 24, 2024

(54) BATTERY PACK

(71) Applicant: TOYOTA JIDOSHA KABUSHIKI KAISHA, Toyota-shi (JP)

(72) Inventors: Mitsutoshi OTAKI, Susono-shi (JP); Shinji NAKANISHI, Mishima-shi (JP); Tetsuya WASEDA, Susono-shi (JP); Jun YOSHIDA, Mishima-shi (JP); Tsubasa MIGITA, Osaka (JP); Yoshihiro UCHIDA, Nagakute-shi (JP)

(73) Assignee: TOYOTA JIDOSHA KABUSHIKI KAISHA, Toyota-shi (JP)

(21) Appl. No.: 18/423,697

(22) Filed: Jan. 26, 2024

(30) Foreign Application Priority Data
Apr. 18, 2023 (JP) 2023-067577

(51) Int. Cl. H01M 50/242; H01M 50/209

(52) U.S. Cl. CPC H01M 50/242; H01M 50/209

(57) ABSTRACT

The control device executes a process including a step of acquiring a detection value from each surface pressure sensor when charging is in progress, a step of specifying a corresponding partially pressing unit when it is determined that there is a portion where the reaction is uneven, a step of outputting a pressing command, a step of determining whether or not pressing is completed, and a step of outputting a pressing cancel command when it is determined that pressing is completed.

### CROSS-REFERENCE TO RELATED APPLICATION

This application claims priority to Japanese Patent Application No. 2023-067577 filed on Apr. 18, 2023, incorporated herein by reference in its entirety.

### BACKGROUND

### 1. Technical Field

The present disclosure relates to configurations of battery packs.

### 2. Description of Related Art

For example, all-solid-state cells, namely cells that are all solid-state using a solid electrolyte, are known as secondary cells. In the all-solid-state cells, adhesion between a positive electrode layer, a solid electrolyte layer, and a negative electrode layer that are constituent members of the cell affects various cell characteristics, and a technique of properly controlling the restraining force (restraining pressure) that is applied to an all-solid-state cell during charging or discharging of the all-solid-state cell is known in the art.

For example, Japanese Unexamined Patent Application Publication No. 2015-095281 (JP 2015-095281 A) discloses a charging system configured to instruct a pressing unit for pressing a cell(s) to press the cell(s) so that the restraining pressure applied during charging is higher than the restraining pressure applied during discharging.

### SUMMARY

However, the adhesion between the positive electrode layer, the solid electrolyte layer, and the negative electrode layer may vary (may be uneven) depending on the structure of each layer even when the restraining pressure is uniformly applied. Accordingly, the reaction may become locally uneven.

The present disclosure was made to solve the above problem, and it is an object of the present disclosure to provide a battery pack that eliminates unevenness in adhesion between constituent members of an all-solid-state cell.

A battery pack according to an aspect of the present disclosure includes: a plurality of all-solid-state cells; and
a restraining unit configured to apply a restraining pressure to a stack of the all-solid-state cells in a stacking direction in which the all-solid state cells are stacked.
   The restraining unit includes a partially pressing unit configured to press part of a contact surface with the stack in the stacking direction in such a manner that the restraining pressure in a portion where a reaction is uneven in at least one of the all-solid-state cells increases.

With this configuration, part of the contact surface is pressed to increase the restraining pressure in the portion where the reaction is uneven. This can improve adhesion between constituent members in the portion where the reaction is uneven in the stack, and can eliminate unevenness in reaction. It is also possible to reduce the possibility of the restraining pressure unnecessarily acting on portions other than the portion where the reaction is uneven.

In a certain embodiment,
the partially pressing unit may be disposed in such a manner that the partially pressing unit is able to press part of the contact surface that is close to a terminal of the all-solid-state cell.

With this configuration, the restraining pressure can be partially increased in the region close to the terminals, namely in the region where the reaction tends to be uneven, in the all-solid-state cells. This can improve adhesion between the constituent members in the region close to the terminals. It is also possible to reduce the possibility of the restraining pressure unnecessarily acting on the portions other than the portion where the reaction is uneven.

In a further embodiment,
the partially pressing unit may be configured to increase the restraining pressure in a section including the portion where the reaction is uneven out of a plurality of sections into which the stack is divided in the stacking direction.

With this configuration, the restraining pressure can be intensively increased in the portion where the reaction is uneven. It is therefore possible to improve adhesion in the portion where the reaction is uneven. It is also possible to reduce the possibility of the restraining pressure unnecessarily acting on other portions.

According to the present disclosure, it is possible to provide a battery pack that eliminates unevenness in adhesion between constituent members of an all-solid-state cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a battery pack;

FIG. 2 is a diagram illustrating an example of a configuration of an all-solid-state cell;

FIG. 3 is a diagram illustrating an example of the configuration of the first pressing unit and the second pressing unit;

FIG. 4 is a flowchart illustrating an example of processing executed in the control device;

FIG. 5 is a diagram illustrating an example of a configuration of a second pressing unit according to a modification;

FIG. 6 is a diagram illustrating an example of a configuration of a surface pressure sensor according to a modification; and

FIG. 7 is a diagram illustrating an example of a configuration of a battery pack according to a modification.

### DETAILED DESCRIPTION OF EMBODIMENTS

Hereinafter, embodiments of the present disclosure will be described in detail with reference to the drawings. It should be noted that the same or corresponding parts in the drawings are designated by the same reference characters and repetitive description will be omitted.

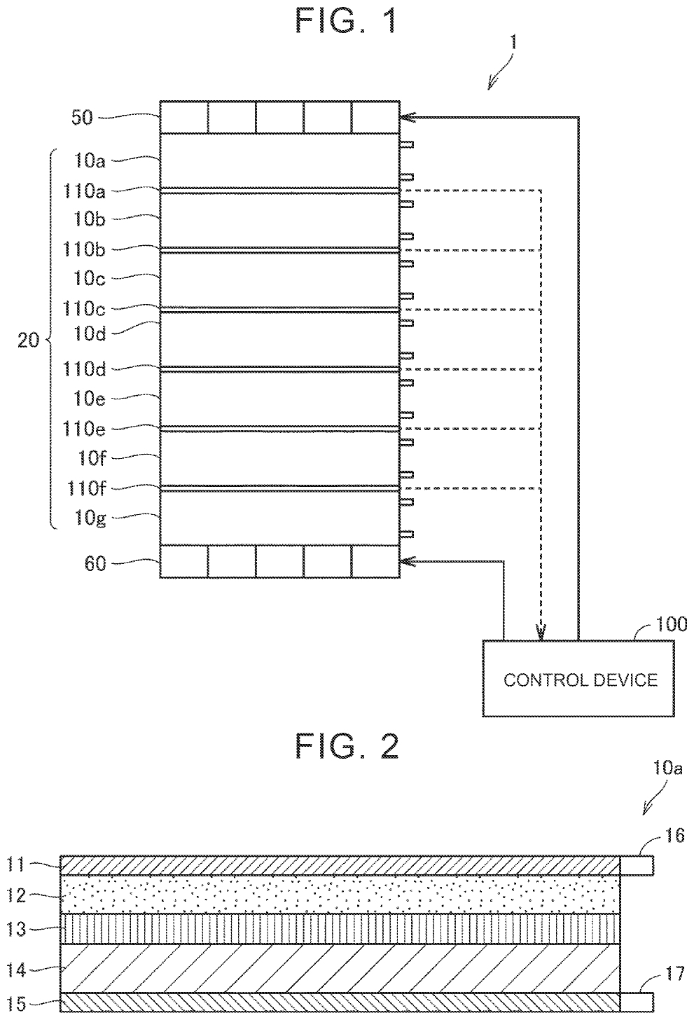

FIG. 1 is a diagram illustrating an example of a configuration of a battery pack 1. For example, the battery pack 1 is mounted on an electrified vehicle such as a battery electric vehicle, plug-in hybrid electric vehicle or another electric moving object. The battery pack 1 shown in FIG. 1 may be charged in a state of being mounted on a vehicle, or may be charged in a state of being removed from the vehicle, for example.

As illustrated in FIG. 1, the battery pack 1 includes a stack 20, a first pressing unit 50, a second pressing unit 60, and a control device 100.

The stack 20 includes a plurality of all-solid-state cells 10a, 10b, 10c, 10d, 10e, 10f, 10g (hereinafter, referred to as all-solid-state cells 10a to 10g) and a plurality of surface pressure sensors 110a, 110b, 110c, 110d, 110e, 110f (hereinafter, referred to as surface pressure sensors 110a to 110f).

The all-solid-state cells 10a to 10g are cells configured by setting a solid electrolyte as an electrolyte, thereby solidifying all the constituent members. Each of the all-solid-state cell 10a to 10g has a rectangular shape. In each of the all-solid-state cells 10a to 10g, the positive electrode terminal and the negative electrode terminal protrude from the right side of the drawing of FIG. 1 and are stacked vertically on the drawing of FIG. 1. In the present embodiment, the stack 20 is described as being composed of seven all-solid-state cells 10a to 10g, but the number of stacks is not limited to seven.

Further, although not particularly shown, each positive electrode terminal and each negative electrode terminal of the all-solid-state cells 10a to 10g are connected to the all-solid-state cells adjoining each other in a predetermined manner. The all-solid-state cells 10a to 10g may be connected in series, for example, or may include a battery group that is partially connected in parallel.

The surface pressure sensor 110a has a sheet-like shape that covers a contact surface with the all-solid-state cell 10a. The surface pressure sensor 110a is provided between the all-solid-state cells 10a, 10b and detects an in-plane pressure (hereinafter, referred to as an in-plane pressure or a surface pressure) between the all-solid-state cells 10a, 10b.

The surface pressure sensor 110a includes detection points of a plurality of surface pressures, and transmits detection results of the surface pressures at the detection points to the control device 100. For example, the control device 100 acquires, from the surface pressure sensor 110a, information obtained by combining the coordinates (detection positions) of the detection points and the detection values of the surface pressure. The surface pressure sensor 110b to 110f is provided between the all-solid-state cells 10b, 10c, the all-solid-state cells 10c, 10d, the all-solid-state cells 10d, 10e, the all-solid-state cells 10e, 10f, and the all-solid-state cells 10f, 10g. Since the operation of the surface pressure sensor 110b to 110f is the same as that of the surface pressure sensor 110a, the detailed explanation thereof will not be repeated.

The first pressing unit 50 and the second pressing unit 60 are provided so as to sandwich the stack 20 from the vertical direction of the paper surface in FIG. 1.

The first pressing unit 50 applies a restraining pressure in the downward direction of the plane of FIG. 1. The first pressing unit 50 is fixed at the position shown in FIG. 1, for example, and has a structure having a member that can expand and contract in the downward direction of the drawing surface of FIG. 1, thereby causing the restraining pressure to act on the stack 20.

The second pressing unit 60 applies a restraining pressure in the upward direction of the plane of FIG. 1. The second pressing unit 60 is fixed at the position shown in FIG. 1, for example, and is configured to have a member that can expand and contract in the upward direction of the drawing surface of FIG. 1, thereby causing the restraining pressure to act on the stack 20. The first pressing unit 50 and the second pressing unit 60 constitute a “restraining unit” that applies a restraining pressure to the stacked 20 in the 15 stacking direction. The positions of the first pressing unit 50 and the second pressing unit 60 are fixed such that a constant restraining pressure acts on the stack 20 in a non-operating state.

The first pressing unit 50 and the second pressing unit 60 operate in accordance with a control signal from the control device 100. The first pressing unit 50 and the second pressing unit 60 operate in accordance with a control signal from the control device 100. Detailed configurations of the first pressing unit 50 and the second pressing unit 60 will be described later.

The control device 100 includes Central Processing Unit (CPU) and memories. The memory includes various memories such as Read Only Memory (ROM) and Random Access Memory (RAM). The control device 100 controls the first pressing unit 50 and the second pressing unit 60 to be in a desired condition based on a signal received from each of the surface pressure sensor 110a to 110f and information (for example, a map and a program) stored in the memory. For example, the control device 100 increases the restraining pressure by the first pressing unit 50 and the second pressing unit 60, or reduces the restraining pressure, based on the detection result of each of the surface pressure sensor 110a to 110f when the battery pack 1 is charged.

FIG. 2 is a diagram illustrating an exemplary configuration of an all-solid-state cell 10a. The all-solid-state cell 10a includes a positive electrode current collector 11, a positive electrode layer 12, a solid electrolyte layer 13, a negative electrode layer 14, a negative electrode current collector 15, a positive electrode terminal 16, and a negative electrode terminal 17. Each of the all-solid-state cells 10b to 10f has the same configuration as that of the all-solid-state cell 10a. Therefore, the detailed description thereof will not be repeated.

The solid electrolyte material included in the solid electrolyte layer 13 is not particularly limited as long as it can be used as a solid electrolyte of an all-solid-state cell. The solid electrolyte material may be, for example, a sulfide-based amorphous solid electrolyte, an oxide-based amorphous solid electrolyte, or the like.

Further, the active material contained in the positive electrode layer 12 and the negative electrode layer 14 is not particularly limited as long as it can be used as an electrode active material of an all-solid-state cell. The active material may be, for example, a material such as nickel-cobalt-manganate (NCM), nickel-cobalt-aluminum-lithium (NCA), lithium cobaltate (LCO), (lithium titanate) LTO, and lithium manganate (LMO). Preferably, it is desirable to have a characteristic that the thickness of the all-solid-state cell including the positive electrode layer 12 and the negative electrode layer 14 increases at a position where the reaction is uneven during charging or discharging of the battery pack 1.

The positive electrode layer 12 and the negative electrode layer 14 may include conductive auxiliary particles. As the conductive auxiliary material particles, for example, graphite, carbon black, or the like can be used.

The material of the positive electrode current collector 11 and the negative electrode current collector 15 is not particularly limited as long as it has conductivity and functions as a positive electrode current collector and a negative electrode current collector, and examples thereof include Steel Use Stainless (SUS), aluminum, copper, nickel, iron, titanium, and carbon. Further, the shapes of the positive electrode current collector 11 and the negative electrode current collector 15 may be, for example, a foil shape, a plate shape, a mesh shape, or the like. The positive electrode terminal 16 is connected to the positive electrode current collector 11. The negative electrode terminal 17 is connected to the negative electrode current collector 15.

As a battery case (not shown) that encloses each of the all-solid-state cells 10a to 10g, a known laminate film etc. that can be used in all-solid-state cells can be used. Examples of such a laminate film include a resin laminate film and a film obtained by depositing metal on a resin laminate film.

As shown in FIG. 1, each of the all-solid-state cells 10a to 10g has a rectangular shape (square shape) as an example. However, the all-solid-state cells 10a to 10g may have a shape in which a restraining pressure can act on the stack 20 of the all-solid-state cells, and may have a desired shape such as a cylindrical shape, a button-type shape, a coin-type shape, or a flat shape in addition to a rectangular shape.

In the all-solid-state cells 10a to 10g included in the battery pack 1 having the above-described configuration, the adhesion between the positive electrode layer 12, the solid electrolyte layer 13, and the negative electrode layer 14 affects various properties of the battery. Therefore, it is desirable to apply a binding force to the all-solid-state cells 10a to 10g and appropriately control the applied binding force.

However, with respect to the adhesion of the constituent members, even if a restraining pressure is applied so as to sandwich the constituent members from the stacking direction, a variation (unevenness) occurs in the contact surface between the members depending on the structure of each constituent member, so that the reaction may become uneven in some cases.

In particular, in the case where the electrolyte layer is a solid, the degree of adhesion between the electrolyte layer and the positive electrode layer or the negative electrode layer is more likely to vary than in the case where the electrolyte layer is a liquid.

Therefore, in the present embodiment, it is assumed that the first pressing unit 50 and the second pressing unit 60 include a partially pressing unit that presses a part of the contact surface with the stack 20 from the stacking direction so that the restraining pressure in the portion where the reaction is uneven in at least one of the all-solid-state cells 10a to 10g increases.

In this case, by pressing a part of the contact surface to increase the restraining pressure in the portion where the reaction is uneven, the adhesion of the constituent members in the portion where the reaction is uneven in the stack 20 can be improved, and unevenness in reaction can be eliminated. In addition, it is possible to suppress an unnecessary restraining pressure from acting on a portion other than the generating portion.

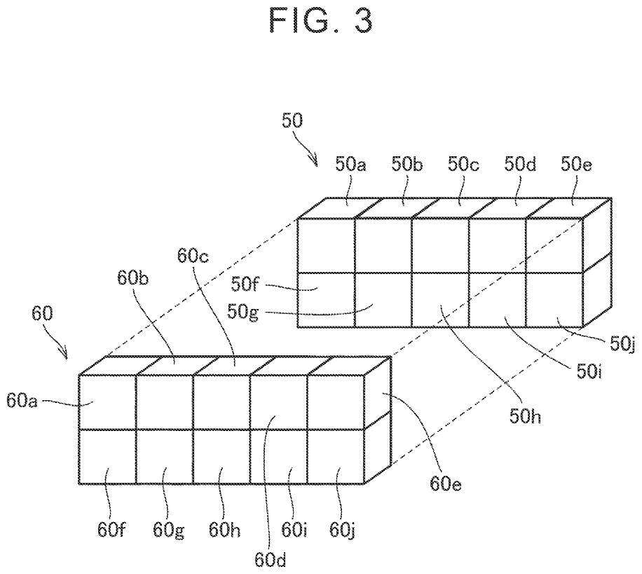

Hereinafter, a specific configuration of the first pressing unit 50 and the second pressing unit 60 will be described with reference to FIG. 3. FIG. 3 is a diagram illustrating an example of the configuration of the first pressing unit 50 and the second pressing unit 60. In FIG. 3, for convenience of explanation, the display of the stack 20 of the battery pack 1 is omitted, and only the first pressing unit 50 and the second pressing unit 60 are displayed.

The first pressing unit 50 includes a first partially pressing unit 50a, 50b, 50c, 50d, 50c, 50f, 50g, 50h, 50i, 50j (hereinafter, referred to as a first partially pressing units 50a to 50j). Each of the first partially pressing units 50a to 50j has a contact surface that is rectangular with respect to one surface in the stacking direction of the stack 20. Each of the first partially pressing units 50a to 50j is provided with an actuator (not shown) that is driven in response to a control signal from the control device 100. At least one of the actuators of the first partially pressing unit 50a to 50j is driven to push the contacting surface with the stack 20, thereby partially increasing the restraining pressure.

The second pressing unit 60 includes second partially pressing units 60a, 60b, 60c, 60d, 60e, 60f, 60g, 60h, 60i, 60j (hereinafter referred to as a second partially pressing units 60a to 60j). The second partially pressing units 60a to 60j is provided at a position facing the first partially pressing units 50a to 50j in the stacking direction. Each of the second partially pressing units 60a to 60j has a contact surface that is rectangular with respect to the other surface of the stack 20 in the stacking direction. Each of the second partially pressing units 60a to 60j is provided with an actuator (not shown) that is driven in response to a control signal from the control device 100. At least one of the actuators of the second partially pressing units 60a to 60j is driven to push the contacting surface with the stack 20, thereby partially increasing the restraining pressure.

For example, when the first partially pressing unit 50a is selected as the control target, the control device 100 selects the second partially pressing unit 60a as the control target. As described above, the control device 100 selects, for example, the first partially pressing units 50a to 50j and the second partially pressing units 60a to 60j as control targets in association with each other.

Control device 100, for example, when selecting the first partially pressing unit 50a and the second partially pressing unit 60a as the control target, the first partially pressing unit 50a and the second partially pressing unit 60a so as to sandwich the contact surface of the first partially pressing unit 50a and the stack 20 and the contact surface of the second partially pressing unit 60a and the stack 20 to apply a partially restraining pressure to the stack 20.

The same applies to the control device 100 in which the first partially pressing unit 50b to 50j and the second partially pressing unit 60b to 60j are controlled. Therefore, the detailed description thereof will not be repeated.

Either of the first partially pressing units 50a to 50j operates to push the stack 20 and the corresponding second partially pressing unit of the second partially pressing units 60a to 60j operates to push the stack 20, thereby partially increasing the restraining pressure between the contact surface of the first partially pressing unit and the contact surface of the second partially pressing unit of the stack 20.

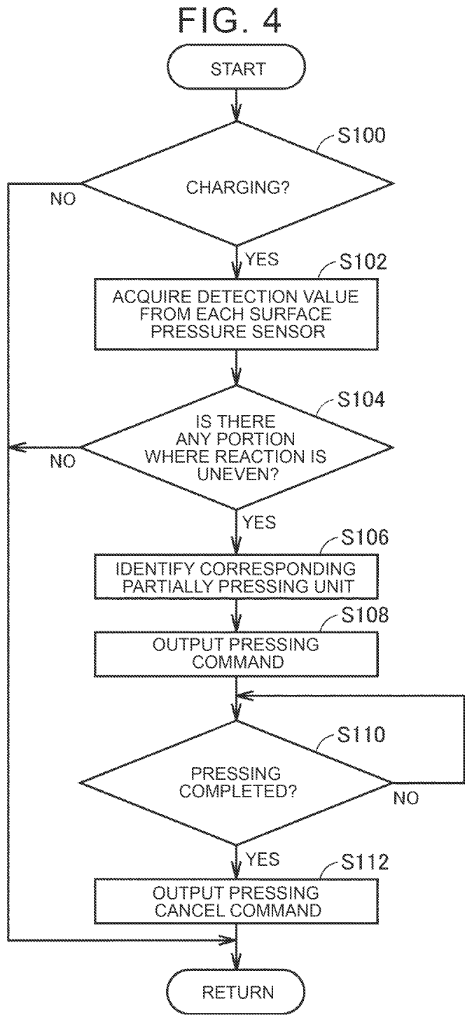

Hereinafter, an example of processing executed by the control device 100 will be described with reference to FIG. 4. FIG. 4 is a flowchart illustrating an example of processing executed by the control device 100. The series of processes shown in this flowchart is repeatedly executed by the control device 100 at predetermined intervals.

In step (hereinafter, step is abbreviated as S) 100, the control device 100 determines whether or not the battery pack 1 is being charged. For example, the control device 100 may determine that the battery pack 1 is charging when a charging current is detected in the battery pack 1 by using a current sensor (not shown) or the like. When it is determined that the battery pack 1 is being charged (YES in S100), the process proceeds to S102.

In S102, the control device 100 acquires a detected value from each of the surface pressure sensor 110a to 110f. The process is then transferred to a S104.

In S104, the control device 100 determines whether there is any portion where the reaction is uneven. Specifically, the control device 100 determines that there is a portion where the reaction is uneven when there is a portion of the plurality of detection points where the surface pressure is higher than the other portions. The control device 100 calculates, for example, an average value of the surface pressures at a plurality of detection points. The control device 100 determines that there is a portion where the reaction is uneven when there is a detection point higher than a value obtained by adding a predetermined value to the calculated average value among the detection values of the surface pressure at the plurality of detection points. When it is determined that there is a portion where the reaction is uneven (YES in S104), the process proceeds to S106.

In S106, the control device 100 identifies the corresponding partially pressing unit. The control device specifies the first partially pressing unit and the second partially pressing unit, which are positional relationships between the detection points identified as a portion where the reaction is uneven, as corresponding partially pressing units. For example, the control device 100 may store in advance a map or the like indicating the relationship between the coordinates of the detection point and the partially pressing unit, and may specify the corresponding partially pressing unit from the coordinates of the detection point corresponding to the portion where the reaction is uneven and the map or the like. The process is then transferred to a S108.

In S108, the control device 100 outputs a pressing command. The control device 100 sets the identified partially pressing unit as a control target, and outputs a pressing command to the set control target. For example, the control device 100 may generate a pressing command such that the restraining pressure increases by a predetermined value, or may generate a pressing command such that the restraining pressure increases by an amount corresponding to a difference between the detection value of the surface pressure at the detection point and the average value of the detection values at each detection point. The process is then transferred to a S110.

In S110, the control device 100 determines whether or not the pressing is completed. For example, the control device 100 determines that the pressing has been completed when a predetermined time has elapsed since the start of the pressing. The process is then transferred to a S112.

In S112, the control device 100 outputs a pressing cancel command. The control device 100 outputs a pressing cancel command to a control target set so that pressing by the partially pressing unit is stopped. The process is then terminated.

The operation of the control device 100 of the battery pack 1 according to the present embodiment based on the above-described structure and flowchart will be described.

For example, it is assumed that the battery pack 1 mounted on the vehicle is charged using an external power source or the like. Further, for example, it is assumed that the reaction is uneven in a portion corresponding to the first partially pressing unit 50a and the second partially pressing unit 60a in the all-solid-state cell 10b of the all-solid-state cells 10a to 10g constituting the stack 20.

When it is determined that the battery pack 1 is being charged (YES in S100), the control device 100 acquires a detected value from each of the surface pressure sensors 110a to 110f (S102). The averaged value of the surface pressure at each of the plurality of detection points is calculated using the obtained detection value of the surface pressure sensor 110a to 110f. When it is determined that the detection value of the surface pressure is larger than the value obtained by adding a predetermined value to the average value at the detection point in the surface pressure sensor 110a among the plurality of detection points, it is determined that there is a portion where the reaction is uneven (YES in S104), and a partially pressing unit corresponding to this portion is identified (S106).

The first partially pressing unit 50a and the second partially pressing unit 60a are specified as partially pressing units corresponding to the portion where the reaction is uneven from the coordinates of the surface pressure sensor 110a determined to have the portion where the reaction is uneven in the surface pressure sensor 110a.

Then, the first partially pressing unit 50a and the second partially pressing unit 60a, which are the specified partially pressing units, are set as control targets, and a pressing command is outputted to the set control targets (S108).

In accordance with the pressing command, the actuator in each of the first partially pressing unit 50a and the second partially pressing unit 60a is driven, the first partially pressing unit 50a presses the contact surface with the stack 20, and the second partially pressing unit 60a presses the contact surface with the stack 20, whereby the restraining pressure in the portion where the reaction is uneven in the stack 20 is locally increased. As a result, the adhesion between the solid electrolyte layer and the positive electrode layer or the negative electrode layer increases, and the resistance decreases, thereby eliminating unevenness in reaction.

When the pressing is completed after a predetermined period of time has elapsed (NO in S110), the pressing cancel command is outputted (S112), whereby the first partially pressing unit 50a and the second partially pressing unit 60a return to the initial state before pressing.

As described above, according to the battery pack 1 of the present embodiment, by pressing a part of the contact surface to increase the restraining pressure in the portion where the reaction is uneven, the adhesion of the constituent members in the portion where the reaction is uneven in the stack 20 can be improved, and unevenness in reaction can be eliminated. In addition, it is possible to suppress an unnecessary restraining pressure from acting on a portion other than the generating portion. Therefore, it is possible to provide a battery pack that eliminates unevenness in adhesion of constituent members in an all-solid-state cell.

When a plurality of portions where the reaction is uneven is detected, a partially pressing unit corresponding to each portion where the reaction is uneven is set as a control target, and a pressing command is output to each set control target.

Modification examples will be described below.

In the above-described embodiment, the case of determining whether there is a portion where the reaction is uneven during charging has been described as an example, but it may be determined whether or not there is a portion where the reaction is uneven during discharging.

Further, in the above embodiment, the pressing is determined to have been completed when a predetermined time has elapsed since the output of the pressing command is described as outputting the pressing cancel command, for example, when the resistance value of the all-solid-state cell including the portion where the reaction is uneven after outputting the pressing command is equal to or less than the threshold value it may be determined that the pressing is completed to output the pressing cancel command.

Further, in the above-described embodiment, the case of eliminating unevenness in reaction in the all-solid-state cell 10a to 10g by pressing using at least one of the first partially pressing units 50a to 50j and the second partially pressing units 60a to 60j has been described as an example, in order to facilitate elimination of unevenness in reaction, for example, in addition to pressing, the stack 20 or the all-solid-state cell 10a to 10g in which the reaction is uneven may be heated control may be executed, or voltage control for changing the voltage may be executed. The heating control may be, for example, control for heating the all-solid-state cell 10a to 10g using a heating device such as a heater, control for loosening the degree of cooling by a cooling device (not shown) provided in the battery pack 1, or control for stopping the cooling by the cooling device. The voltage control may be a control for increasing the voltage of the all-solid-state cell in which the reaction is not uneven during charging, or a control for stopping charging. Further, the voltage control may be a control for lowering the voltage of the all-solid-state cell in which the reaction is not uneven during discharge, or a control for stopping discharge.

Further, in the above-described embodiment, the first partially pressing unit 50a to 50j and the second partially pressing units 60a to 60j each have the contact surface having the same area with respect to the stack 20 has been described as an example, but each of the first partially pressing units 50a to 50j and the second partially pressing unit 60a to 60j may have the contact surface having a different area or shape with respect to the stack 20.

For example, the plurality of partially pressing units may be arranged so as to be capable of pressing a part of the contact surface of the contact surface with the stack 20 that is closer to the terminals (the positive electrode terminal and the negative electrode terminal) of the all-solid-state cells 10a to 10g. Alternatively, the plurality of partially pressing units may be concentrated on the side closer to the terminal.

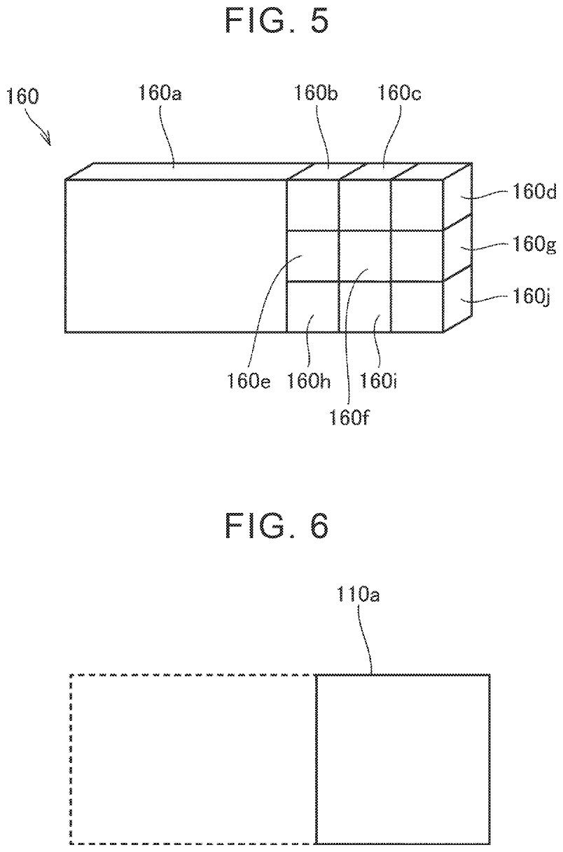

FIG. 5 is a diagram illustrating an example of the configuration of the second pressing unit 160 according to the modification. In FIG. 5, for convenience of explanation, the display of the stack 20 and the first pressing unit of the battery pack 1 is omitted, and only the second pressing unit 160 is displayed.

As illustrated in FIG. 5, the second pressing unit 160 includes a second partially pressing units 160a, 160b, 160c, 160d, 160c, 160f, 160g, 160h, 160i, 160j (hereinafter, referred to as a second partially pressing units 160a to 160j).

The second partially pressing units 160a has a rectangular contact surface with the stack 20, and has a contact surface having the largest contact surface area with the stack 20 as compared with the second partially pressing units 160b to 160j. On the other hand, each of the second partially pressing units 160b to 160j has a rectangular shape and has substantially the same area as the contact surface with the stack 20.

The first pressing unit has a plurality of first partially pressing units having the same shape as the second pressing unit 160. The plurality of first partially pressing units are disposed at positions facing the second partially pressing units 160a to 160j.

In this way, the restraining pressure can be partially increased with respect to a region close to the terminal, in which the reaction is likely to be uneven in the all-solid-state cell. Therefore, the adhesiveness of the constituent member in the region close to the terminal can be improved. In addition, it is possible to suppress an unnecessary restraining pressure from acting on a portion other than the generating portion. Note that the second partially pressing unit 160a and the corresponding first partially pressing unit may be configured by omitting a mechanism that enables pressing. In this way, it is possible to dispose the partially pressing units so that a part of the contact surface closer to the terminal can be pressed. In this case, the shape of the sheet including the detection point of the surface pressure sensor may be not a shape covering the surface of the all-solid-state cell in the stacking direction, but a shape covering the region of the portion where the stack 20 and the partially pressing units come into contact with each other. FIG. 6 is a diagram illustrating an example of a configuration of a surface pressure sensor according to a modification. By arranging the partially pressing units in the region close to the terminal and having a shape covering the contact surface between the partially pressing units and the stack 20 as shown by the solid line in FIG. 6, it is possible to reduce the shape of the sheet including the detection point of the surface contact sensor as compared with the case of covering the entire surface in the stacking direction of the all-solid-state cell including the broken line in FIG. 6.

Further, in the above-described embodiment, the first pressing unit 50 and the second pressing unit 60 is provided so as to sandwich the stack 20, the structure for applying the restraining pressure to the entire stack 20 with respect to the stacking direction of the stack 20 has been described as an example, but the configuration is not particularly limited to such a configuration.

For example, in addition to the first pressing unit 50 and the second pressing unit 60, a third pressing unit may be included to partially increase the restraining pressure in a section including a generation region among a plurality of sections obtained by dividing the stack 20 in the longitudinal direction.

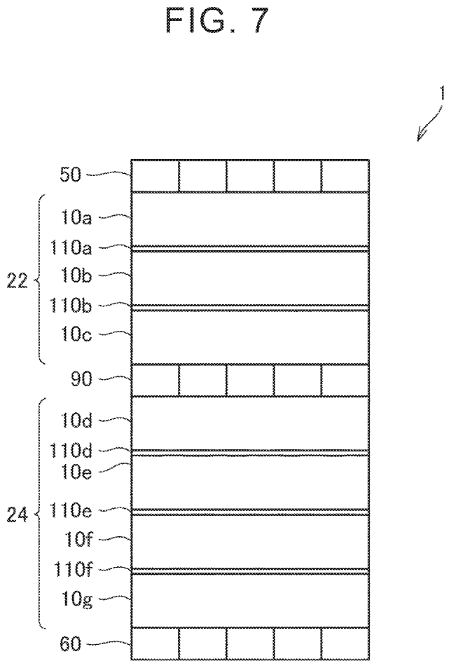

FIG. 7 is a diagram illustrating an example of a configuration of a battery pack 1 according to a modification. As shown in FIG. 7, the battery pack 1 includes a third pressing unit 90 in place of the surface pressure sensor 110c in the configuration described with reference to FIG. 1. The third pressing unit 90 is provided so as to sandwich the first stacked body 22 including the three all-solid-state cells 10a to 10c with the first pressing unit 50. Further, the third pressing unit 90 is provided so as to sandwich the second stacked body 24 including the remaining all-solid-state cells 10d to 10g with the second pressing unit 60. The third pressing unit 90 includes a plurality of third partially pressing units (not shown). The third pressing unit is configured to press both the first stacked body 22 and the second stacked body 24. Each of the plurality of third partially pressing units operates in response to a control signal from the control device 100, and is provided at a position corresponding to each of the partially pressing units of the first pressing unit 50 and the pressing unit of the second pressing unit 60. The third pressing unit 90 may be provided to be fastened to, for example, a pedestal or the like that fixes the battery pack 1, or may be restricted in position by fixing the first pressing unit 50 and the second pressing unit 60 in the same manner as the adjacent first stacked body 22 and the second stacked body 24.

The control device 100 identifies a portion where the reaction is uneven by using the detection results at a plurality of detection points using the surface pressure sensor 110a, 110b, 110d, 110e, 110f, and operates a partially pressing unit corresponding to the identified portion.

For example, when it is determined that there is a portion where the reaction is uneven in the first stacked body 22, the control device 100 operates the partially pressing unit corresponding to the generated portion in the first pressing unit 50 and the third pressing unit 90 to partially increase the restraining pressure.

Further, for example, when it is determined that there is a portion where the reaction is uneven in the second stacked body 24, the control device 100 operates the partially pressing unit corresponding to the generated portion in the third pressing unit 90 and the second pressing unit 60 to partially increase the restraining pressure.

In this case, since the restraining pressure can be increased by concentrating the portion where the reaction is uneven, it is possible to improve the adhesion in the region where the reaction is uneven, and it is possible to suppress the action of the restraining pressure unnecessarily on the other portion.

All or some of the above-mentioned modified examples may be combined for implementation.

It should be considered that the embodiments disclosed above are for illustrative purposes only and are not limitative of the disclosure in any aspect. The scope of the disclosure is represented by the appended claims, not by the above description, and includes all modifications within the meanings and scope equivalent to the claims.

What is claimed is:

1. A battery pack, comprising:
a plurality of all-solid-state cells; and
a restraining unit configured to apply a restraining pressure to a stack of the all-solid-state cells in a stacking direction in which the all-solid state cells are stacked, wherein the restraining unit includes a partially pressing unit configured to press part of a contact surface with the stack in the stacking direction in such a manner that the restraining pressure in a portion where a reaction is uneven in at least one of the all-solid-state cells increases.

2. The battery pack according to claim 1, wherein the partially pressing unit is disposed in such a manner that the partially pressing unit is able to press part of the contact surface that is close to a terminal of the all-solid-state cell.

3. The battery pack according to claim 1, wherein the partially pressing unit is configured to increase the restraining pressure in a section including the portion where the reaction is uneven out of a plurality of sections into which the stack is divided in the stacking direction.
